(19) United States
(12) Patent Application Publication
(10) Pub. No.: US 2017/0083903 A1
(43) Pub. Date: Mar. 23, 2017

(54) TRASH CONTAINER

(71) Applicant: Jonathan L. Knight, Nashville, IN (US)

(72) Inventor: Jonathan L. Knight, Nashville, IN (US)

(21) Appl. No.: 15/265,414

(22) Filed: Sep. 14, 2016

Related U.S. Application Data
(60) Provisional application No. 62/219,893, filed on Sep. 17, 2015.

(51) Int. Cl. G06Q 20/34; G07F 5/02; G06Q 20/32; B65F 1/16

(52) U.S. Cl. CPC G06Q 20/34; B65F 1/1615; B65F 1/1623; B65F 1/1646; G07F 5/02; G06Q 20/3278; B65F 2210/148; B65F 2210/167

(57) ABSTRACT

The invention provides trash containers useful for preventing unauthorized or excess authorized trash from being deposited into the trash containers. The trash containers comprise a body; an opening; a lid attached to the body; a latch means; a latch means receptacle; and a coin-operated mechanism. Individuals that want to deposit trash must gain access to the trash containers by paying a fee via the coin-operated mechanism to activate the latch and allow the individual to open the lid and insert trash into the trash containers. In some embodiments, the trash containers are configured to allow only a certain amount of trash to be deposited into the trash containers per fee paid.

### CROSS REFERENCE TO RELATED APPLICATIONS

This application claims priority to U.S. Provisional Application Ser. No. 62219893 filed Sep. 17, 2015, the disclosure of which is incorporated herein by this reference.

### BACKGROUND OF THE INVENTION

Field of the Invention

The invention relates generally to trash containers and particularly to trash containers that prevent unauthorized trash or excess authorized trash from being deposited into the trash containers.

Description of Related Art

Commercial establishments, recreational areas, roadside parks, recreational vehicle parks, and the like often have one or more trash containers that are used to collect trash that is deposited into the trash container by authorized users, e.g., owners of the commercial establishments or customers of the recreational areas. Unfortunately, unauthorized users depositing any trash into the container or authorized users depositing more trash than authorized into the container creates an excess of trash that must be disposed of by the owner or manager of the trash container, e.g., the commercial establishment owners or recreational area managers must pay a fee to dispose of the excess trash. Such owners and managers are often looking for ways to prevent unauthorized trash or excess authorized trash from being deposited into their trash containers.

Methods and devices for preventing unauthorized or excess trash from being deposited into a trash container are known in the art. Typically, the trash containers are secured by lock mechanisms (e.g., a latch secured by a padlock), frame mechanisms (e.g., a frame secured with a chain and a padlock), or similar devices so that only those with a key can access the trash container and deposit trash into the container. Also, guards are often posted to monitor the trash containers and prevent unauthorized or excess trash from being deposited into the trash containers.

U.S. Pat. No. 4,182,530 discloses a commercial trash bin with locking arrangements that restrict the use of the trash bin to an authorized user but still permits dumping of the trash bin without wasting any extra time by the garbage truck operator. The lids are provided with a special latch which is disabled to permit dumping through gravity action when the trash bin is lifted and inverted and dumped. In one embodiment, the mechanism includes a heavy spring that is compressed by the weight of the trash bin. In another embodiment, a gravity operated latch releasing mechanism is employed. For each, a key-operated release, either in the form of a padlock or a built-in lock mechanism, is used to open the trash bin while it is in the upright position.

U.S. Pat. No. 5,419,598 discloses an apparatus for securing a lid of a trash bin using a frame attached to a wall of the trash bin. The frame defines a housing that encloses moving parts of the locking mechanism. This housing inhibits tampering with the locking mechanism and protects the locking mechanism against exposure to the trash placed in the bin. In addition, the apparatus includes a coupler for holding the housing against the wall of the trash bin so as to prevent unauthorized access from outside the trash bin while permitting an individual locked inside the trash bin to decouple a portion of the frame from the bin to permit the individual to exit the bin.

U.S. Pat. No. 5,599,050 discloses gravity activated lid-locking devices for trash containers that use mechanisms enclosed in a security box attached to the front of the trash container.

U.S. Pat. No. 7,597,365 discloses automatic gravity actuated container lid locking mechanisms for bulk trash containers. The mechanism includes a counterweighted actuator arm pivotally attached to a first housing affixed to a first sidewall of the container, a crossbar across the lid of the container, and a dummy arm pivotally attached to a second housing affixed to a second sidewall of the container. The crossbar pivots forward to unlock the lid when the container is tilted up for dumping and pivots back to lock the lid when the container is tilted down. Alternatively, the crossbar may be pivoted forward when the lock is manually unlocked by sliding a counterweighted pin assembly on the first housing from a position interfering with the motion of the actuator arm to a position allowing the motion of the actuator arm.

These methods and devices are somewhat effective for preventing unauthorized trash or authorized excess trash from being deposited into trash containers but are often cumbersome and/or expensive. Having to manage keys to throw-away the trash is burdensome and inconvenient and paying a guard to watch trash containers is an unwanted and burdensome expense. There is, therefore, a need for novel trash containers and methods for managing trash that prevent unauthorized trash or excess authorized trash from being deposited into trash containers.

### SUMMARY OF THE INVENTION

It is, therefore, an object of the invention to provide trash containers that prevent unauthorized trash or excess authorized trash from being deposited into the trash containers.

It is another object of the invention to provide methods for preventing unauthorized trash or excess authorized trash from being deposited into trash containers.

These and other objects of the invention are achieved through the use of trash containers that require an individual wanting to deposit trash into the trash containers to pay a fee that triggers a coin-operated mechanism that operates a latch that allows a lid on the trash container to be opened. After opening the lid, the individual deposits trash into the trash container and the lid closes. Then, to deposit additional trash, the individual must pay an additional fee. Similarly, a different individual that wants to deposit trash into the trash container must pay a fee before depositing the trash. Requiring a fee each time trash is deposited into the trash container impairs the ability of individuals to deposit unauthorized or excess authorized trash into the container.

Other and further objects, features, and advantages of the present invention will be readily apparent to those skilled in the art.

This summary is provided to introduce a selection of concepts in a simplified form that are further described below in the detailed description of the invention. This summary is not intended to identify key features or essential features of the claimed invention nor is it intended to be used to limit the scope of the claimed invention.

### DETAILED DESCRIPTION OF THE INVENTION

### Definitions

The term “authorized trash” means trash for which a fee has been paid in exchange for placing the trash into the trash container.

The term “essentially seal” means that the opening is blocked such that it is difficult or impossible to deposit or remove trash from a trash container through an opening when a lid is placed over the opening.

The term “excess authorized trash” means an amount of trash that exceeds the amount of trash that has been authorized for deposit into the trash container in exchange for a fee, e.g., a third bag of trash that an individual attempts to deposit into the trash container when a fee authorizing only two bags to be deposited has been paid.

The terms “prevent” and “preventing” when referring to trash deposits herein mean that an individual depositing trash will hopefully be prevented from depositing unauthorized or excess authorized trash into a trash container of the invention but also mean that the individual will be impaired or restricted when attempting to make such deposits.

The term “unauthorized trash” means trash for which a fee has not been paid in exchange for placing the trash into the trash container.

The term “coin-operated mechanism” is used generically herein to represent numerous means and devices known to skilled artisan for receiving a payment or identifying an authorized user and activating a coupled mechanism that produces a desired result. For example, coin-operated mechanisms are used on vending machines to receive coins, paper money, credit cards, and the like as a payment means and, after receiving the payment, activate the mechanism in the vending machine that dispensed a product, e.g., a drink or snack. Coin-operated mechanisms also dispense transportation vouchers such as train tickets, bus tickets, and airline tickets. Such mechanisms also dispense sporting or other event admission tickets at stadiums and other locations. Some coin-operated mechanisms do not require at-site remuneration to operate but instead are capable of reading a magnetic or similar card that has been pre-paid to allow unlimited access or pre-paid with a certain value stored on the card, e.g., cards that allow a user to unlimited access to the garage for a month or an automatic sensor that deducts a toll from a user account as a vehicle passes the sensor.

### The Invention

In one aspect, the invention provides trash containers useful for preventing unauthorized or excess authorized trash from being deposited into the trash containers. The trash containers comprise a body defining a substantially enclosed inner area suitable for receiving and containing trash; an opening in the body suitable for inserting trash into and removing trash from the body; a lid attached by one or more hinges to the body, the lid being configured to match the shape and size of the opening such that the body and the lid form an essentially enclosed inner area when the lid is placed over the opening; a latch means affixed to either the lid or to the body; an latch means receptacle affixed to either the lid or to the body, wherein the latch means receptacle is affixed to the lid if the latch means is affixed to the body or the latch means receptacle is affixed to the body if the latch means is affixed to the lid, wherein the lid is essentially sealed to the opening by operating the latch means so that the latch means is inserted into the latch means receptacle; and a coin-operated mechanism attached to the body or to the lid and coupled to the latch means such that the coin-operated mechanism is capable of operating the latch means to insert at least a portion of the latch means into or remove the latch means from the latch means receptacle, wherein the coin-operated mechanism is activated to remove the latch means from the latch means receptacle when a payment means triggers the coin-operated mechanism.

The trash container body can be any shape and size. Typically, the trash container body is basically a square or rectangular shaped container known to skilled artisans. Such trash containers can be seen in alleys behind commercial establishments, at construction sites, in roadside parks, at recreational events, and the like. The trash container body can also be round or tubular, e.g., the trash container typically used for smaller establishments or for households. The trash container body can be of any shape that is convenient for the user when using the container to receive deposited trash, e.g., configured to fit into a particular shaped space. In some embodiments, the trash container is pentagonal, hexagonal, or octagonal. In some embodiments, the trash container body is shaped and sized to facilitate handling by mechanical devices, e.g., trash collection vehicles common in the art.

The trash container body forms a substantially enclosed inner area for containing trash. The substantially enclosed inner area is an area that retains the trash when deposited but has an opening that permits trash to be deposited into such area. In some embodiments, the trash container body has venting, drainage, or other small openings that allow air and water to enter and exit the trash container but do not permit substantial amounts of trash from exiting the trash container.

The trash container body has at least one opening suitable for depositing trash into the substantially enclosed inner area of container or removing trash from such inner area. The opening can be any size, shape, and location relative to the trash container body that is useful and convenient for depositing trash into the container, e.g., square hole on the top or side of the container that can accommodate a 30-gallon trash bag filled with trash. The opening is typically circular, oval, square, or rectangular, but can be pentagonal, hexagonal, octagonal, or any suitable shape that permits trash to be deposited into the trash container. The opening is typically in the top of or on the side of the trash container, but can be located anywhere that is convenient for depositing trash into the trash container.

A lid is affixed to the trash container body by hinges or similar devices such that the lid can be opened to allow trash to be deposited into the container through the opening in the body or closed to essentially seal the opening and form an essentially enclosed inner area defined by the body and the closed lid. The lid is configured to match the shape and size of the opening such that the body and the lid form an essentially enclosed inner area when the lid is placed over the opening.

In a preferred embodiment, the trash container has a rectangular-like body with an opening that is essentially sealed by a hinged lid that covers the opening. The lid can be opened to receive deposits of trash into the substantially enclosed inner area formed by the body, closed to form an essentially enclosed inner area suitable for retaining the trash deposited into the body, and opened if needed to allow the trash to be removed from the body of the trash container. In some embodiments, the trash container body has an opening for depositing trash and another opening, often larger, for removing the trash.

In one embodiment, the trash container comprises stationary section and a moveable section that can be attached and detached using fasteners. The stationary section comprises the lid, the opening, the latch means, the latch mean receptacle, and the coin-operated mechanism and the moveable section comprises the remainder of the trash container. The stationary section can be attached and detached from the moveable section using any suitable fastener means, e.g., clamps, clasps, bolts, snap fastener, and the like, or combinations thereof. In this embodiment, periodically or when the trash container if filled with trash, the moveable section is detached from the stationary section, emptied of trash, and reattached to the stationary section. This embodiment facilitates the quick and easy removal of trash from the trash container while minimizing the risk of damage to the other components of the trash container, e.g., the latch and coin-operated mechanism. In another embodiment, the moveable section is detached and taken away to another location for emptying and processing, e.g., cleaning or repairs, and a different identical or similar empty moveable section is attached to the stationary section. This embodiment not only facilitates the quick and easy removal of trash from the trash container but also allows the stationary section to remain in place and collect fees while the removable section is cleaned, repaired, or replaced.

The latch means and latch means receptacle are any suitable combination of latch means and latch means receptacle capable of engaging each other and securing the lid to the trash container body. Numerous such latch means and latch means receptacles are known to skilled artisans. Typical “latches” comprising the latch means and latch means receptacle are deadbolt latches, slam latches, spring latches, cam lock latches, crossbar latches, compression latches, draw latches, rotary latches, and the like. In operation, such latches function as a mechanical fastener that joins the lid and the trash container body together while allowing for the regular or eventual separation of the lid and the trash container body.

In one embodiment, a latch means is affixed to the container body and a latch means receptacle is affixed to the lid. In another embodiment, a latch means is affixed to the lid and a latch means receptacle is affixed to the container body. The latch means and latch means receptacle are configured so that the latch means can be a moved to engage the latch means receptacle and prevent the lid from being opened. When the latch means and latch means receptacle are engaged, the lid cannot be opened and trash cannot be inserted into or removed from the trash container. Generally, the latch means is affixed to the trash container body or lid by welds, bolts, or similar means and latch means receptacle is affixed to the trash container body or lid by similar means. The latch means and latch means receptacle are placed on the trash container body and the lid so that they are adjacent to each other when the lid is closed, i.e., covers the opening.

In other embodiments, the latch means and latch means receptacle are affixed to the container body or lid such that the latch means and latch means receptacle are contained within the body or lid. In one such embodiment, the latch means is a bolt that, when moved, protrudes from the body or lid and enters a corresponding space on the body or lid designed to receive the bolt and prevent the lid from being opened. Many such mechanisms are known to skilled artisans, e.g., the deadbolt lock on a door that enters the corresponding hole in the door frame.

In some embodiments, the latch means receptacle is simply a position occupied by the latch means when the latch means is activated to prevent opening of the lid. For example, the latch means can be a bolt, bar, brace, or similar device that is moved into position such that it prevents the lid from being opened because the latch means contacts the lid, blocks its movement, and prevents it from being moved to the open position.

The coin-operated mechanisms of the invention are any device that accepts payment or recognizes that a payment has been made and triggers the mechanism to operate the latch means in a manner that allows the lid to be opened so that trash can be deposited into the trash container body through the opening. As discussed above, many such coin-operated mechanisms are known in the art. For example, in one embodiment, the coin-operated mechanism is a vending machine coin mechanism that accepts coins or paper bills to trigger the coin-operated mechanism and remove the coupled latch means from the latch means receptacle. In other embodiments, the coin-operated mechanism is a currency detector, currency validator, credit card reader, or credit card terminal that accepts one or more forms of currency or credit, triggers the coin-operated mechanism, and removes the coupled latch means from the latch means receptacle.

In preferred embodiments, the coin-operated mechanism accepts and identifies one more of coins, paper money, credit cards, debit cards, tokens, magnetic stripe cards, magnetic field or radio frequency (RFID) devices, or combinations thereof.

The coin-operated mechanism coupled to the latch means is capable of operating the latch means to insert the latch means into or remove the latch means from the latch means receptacle. When the latch means receptacle is a position, the latch means is simply removed from the position and allows the lid to be opened. The mechanism is activated to remove the latch means from the latch means receptacle when a payment means triggers the device.

The coin-operated mechanisms may be attached to the trash container body or to the lid, typically in close proximity to the latch means.

The payment means is means for making payment for access to the trash container. For example, the payment means is coins, paper money, or credit card. Many such payment means are known in the art. In one embodiment, the payment means is an access card allowing an individual to trigger the coin-operated mechanism without inserting money, using a credit card, or similar means of on-site payment. Such means is typically used when an individual has paid a fee for periodic access to the trash container, e.g., a restaurant owner that has paid a fee for access to the trash container for a month.

In preferred embodiments, the payment means is one or more of coins, paper money, credit cards, debit cards, tokens, magnetic stripe cards, magnetic field or radio frequency (RFID) devices, or combinations thereof.

In a typical situation, the trash container of the invention is placed in a location where individuals wanting to dispose of trash can easily access the trash container, e.g., in a public area, in a trash disposal retail establishment, or in a recreational area. An individual brings trash to deposit into the trash container. The individual inserts coins and/or paper money into the coin-operated mechanism in an amount sufficient to pay the fee required to trigger the coin-operated mechanism and thereby remove the latch means from the latch means receptacle. Once the latch means is removed from the latch means receptacle, the individual can open the lid and deposit trash into the trash container. In another situation, the individual uses a credit card to pay the fee. In another situation, the coin-operated mechanism senses the presence of a prepaid access card and triggers the coin-operated mechanism.

Any method to pay the fee is acceptable in the present invention, e.g., payment using smart phones, smart watches, and the like can be used to pay the fee.

In one embodiment, an individual or business rents a trash container of the invention and deposits trash into the container periodically during the rental period. The individual or business is given an access card that has payment means encoded on the access card. The payment means can be a certain amount that authorizes the individual or business to deposit a certain amount of trash before the access card will no longer activate the coin-operated mechanism or an unlimited amount that authorizes the individual or business to deposit unlimited amounts trash in the trash container, i.e., limited only by the size of the trash container and the frequency that the trash container is emptied.

The trash container body and lid can be made from any material suitable for containing trash. Typically, the body and lid are made from metal or plastic.

In some embodiments, the trash container further comprises a means or device for limiting the amount of trash that can be deposited into the trash container each time the lid is opened. Such means or devices are known to skilled artisans, e.g., the device on the lid of a public mail box that allows mail to be put into the lid but will not deposit the mail into the mail box until the lid is closed. For example, the lid may have a scoop affixed to the lid such that only the amount of trash that fits into the scoop can be deposited into the trash container each time the lid is opened. The lid is opened, the scoop is filled with trash, and the lid is closed to deposit the trash into the trash container. In this embodiment, an individual wanting to deposit authorized trash into the trash container is given permission via the payment means to open the lid, fill the scoop with trash, and close the lid to deposit the trash into the container. Upon closing the lid, the latch means is engaged by the latch means receptacle and the lid cannot be opened to deposit additional trash into the trash container. If the individual has additional or excess trash to deposit into the trash container, the individual cannot deposit the excess trash into the trash container without obtaining permission via another payment means. Without this additional payment, the individual will be prevented from depositing additional trash into the trash container.

In some embodiments, the trash container further comprises a means or device for ensuring the lid closes if the lid is not being held open. Such means or devices are known to skilled artisans, e.g., a spring or piston. For example, the lid may have a spring attached to the lid and the body of the trash container that applies force to close the lid when the lid is unattended. In this embodiment, an individual depositing trash into the trash container opens the lid and holds the lid open while depositing the trash. When the individual releases the lid, the force applied by the spring closes the lid. Generally, gravity closes the lid when it is not being held open. Typical devices known to skilled artisans, albeit for toilet seats, are shown in U.S. Pat. No. 4,912,783 and U.S. Pat. No. 5,774,904.

In some embodiments, the trash container further comprises a means or device for sensing when the lid is open or closed and communicating the open-closed status of the lid to other components of the trash container, e.g., the coin-operated mechanism or the latch. Such means or devices are known to skilled artisans, e.g., reed sensors similar to those used in laundry machines. For example, the lid may have a reed sensor that senses when the lid is closed and, via a wireless or mechanical electrical connection, triggers the coin-operated mechanism to activate the latch means to ensure that the lid cannot be opened unless another fee is paid. In other embodiments, the latch may be “locked” or “unlocked” by such means or device.

In one embodiment, the coin-operated mechanism further comprises a timer that allows the coin-operated mechanism to permit access to the trash container only at predetermined intervals or at predetermined times of the day. Thus, a trash container of the invention that limits the amount of trash that can be deposited into the trash container when the lid is opened can, with the aid of the timer, prevent the amount of excess trash that can be deposited into the trash container by limiting the amount of time that any trash can be deposited into the trash container. For example, a timer that only permits the lid to be opened from 6 AM to 6 PM will prevent unauthorized trash or excess authorized trash from being deposited into the trash containers during the period from 6 PM to 6 AM.

For many commercial operations and large residential users of trash services, a large stationary container is provided to receive trash. Typically, these containers consist of a large steel receptacle having access lids for depositing trash and also for permitting the trash to be emptied. Such containers are generally adapted to be mechanically raised by a waste disposal truck equipped to tip the container to a position where the trash will discharge by gravity into the truck. Such containers can form a trash container of the invention by adapting them to comprise a latch means, latch means receptacle, coin-operated mechanism, and the like according to the present position.

In another aspect, the present invention provides methods for preventing the deposit of unauthorized trash or excess authorized trash into trash containers. The methods comprise (1) providing individuals wanting to deposit trash into a trash container with access to a trash container comprising a body defining a substantially enclosed inner area suitable for receiving and containing trash; an opening in the body suitable for inserting trash into and removing trash from the body; a lid attached by one or more hinges to the body, the lid being configured to match the shape and size of the opening such that the body and the lid form an essentially enclosed inner area when the lid is placed over the opening; a latch means affixed to either the lid or to the body; an latch means receptacle affixed to either the lid or to the body, wherein the latch means receptacle is affixed to the lid if the latch means is affixed to the body or the latch means receptacle is affixed to the body if the latch means is affixed to the lid, wherein the lid is essentially sealed to the opening by operating the latch means so that the latch means is inserted into the latch means receptacle; and a coin-operated mechanism attached to the body or to the lid and coupled to the latch means such that the coin-operated mechanism is capable of operating the latch means to insert at least a portion of the latch means into or remove the latch means from the latch means receptacle, wherein the coin-operated mechanism is activated to remove the latch means from the latch means receptacle when a payment means triggers the coin-operated mechanism and (2) requiring the individual to pay a fee using the coin-operated mechanism and the payment means to deposit an authorized amount of trash.

If an individual attempts to deposit unauthorized trash into the trash container, the individual cannot gain access to the trash container since the latch means and latch means receptacle prevents the individual from opening the lid and depositing the trash. Once the individual uses a payment means to pay the required fee, the trash becomes authorized trash and can be deposited into the trash container via the opening in the trash container body that is accessible when the unlatched lid is moved to expose the opening. In embodiments of the trash container that contain a means for limiting the amount of trash deposited into the trash container per fee, the method essentially requires the individual to pay a fee for an authorized amount of trash deposited and an additional fee for an amount of trash that would exceed the authorized amount, e.g., the individual would have to pay a fee, fill a scoop with trash, close the lid to empty the scoop, an pay an additional fee to open the lid and gain access to the scoop.

As used herein, the singular form of a word includes the plural, and vice versa, unless the context clearly dictates otherwise. Thus, the references “a”, “an”, and “the” are generally inclusive of the plurals of the respective terms. For example, reference to “a method” includes a plurality of such “methods.” Similarly, the words “comprise”, “comprises”, and “comprising” are to be interpreted inclusively rather than exclusively. Likewise, the terms “include”, “including” and “or” should all be construed to be inclusive, unless such a construction is clearly prohibited from the context.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

Unless defined otherwise, all technical and scientific terms, terms of art, and acronyms used herein have the meanings commonly understood by one of ordinary skill in the art in the field(s) of the invention, or in the field(s) where the term is used. Although any, methods, systems, or other means or materials similar or equivalent to those described herein can be used in the practice of the present invention, the preferred methods, systems, or other means or materials are described herein.

In the specification, there have been disclosed typical preferred embodiments of the invention. Although specific terms are employed, they are used in a generic and descriptive sense only and not for purposes of limitation. The scope of the invention is set forth in the claims. Many modifications and variations of the invention are possible in light of the above teachings. It is therefore to be understood that within the scope of the appended claims, the invention may be practiced otherwise than as specifically described.

What is claimed is:

1. A trash container comprising:
a body defining a substantially enclosed inner area suitable for receiving and containing trash;
an opening in the body suitable for inserting trash into and removing trash from the body;
a lid attached by one or more hinges to the body, the lid being configured to match the shape and size of the opening such that the body and the lid form an essentially enclosed inner area when the lid is placed over the opening;
a latch means affixed to either the lid or to the body;
an latch means receptacle affixed to either the lid or to the body, wherein the latch means receptacle is affixed to the lid if the latch means is affixed to the body or the latch means receptacle is affixed to the body if the latch means is affixed to the lid, wherein the lid is essentially sealed to the opening by operating the latch means so that the latch means is inserted into the latch means receptacle; and
a coin-operated mechanism attached to the body or to the lid and coupled to the latch means such that the coin-operated mechanism is capable of operating the latch means to insert at least a portion of the latch means into or remove the latch means from the latch means receptacle, wherein the coin-operated mechanism is activated to remove the latch means from the latch means receptacle when a payment means triggers the coin-operated mechanism.

2. The trash container of claim 1 wherein the coin-operated mechanism accepts and identifies one more of coins, paper money, credit cards, debit cards, tokens, magnetic stripe cards, magnetic field or radio frequency (RFID) devices, or combinations thereof.

3. The trash container of claim 1 wherein the payment means is one or more of coins, paper money, credit cards, debit cards, tokens, magnetic stripe cards, magnetic field or radio frequency (RFID) devices, or combinations thereof.

4. The trash container of claim 1 comprising a stationary section and a moveable section, wherein the stationary section and a moveable section can be attached and detached.

5. The trash container of claim 4 wherein the stationary section and moveable section are attached and detached using clamps, clasps, bolts, snap fasteners, or a combination thereof.

6. The trash container of claim 1 further comprising a means or device for limiting the amount of trash that can be deposited into the trash container each time the lid is opened.

7. The trash container of claim 6 wherein the means or device is a scoop affixed to the lid.

8. The trash container of claim 1 further comprising a means or device for ensuring the lid closes if the lid is not being held open.

9. The trash container of claim 8 wherein the means or device is a spring attached to the lid and the body of the trash container.

10. The trash container of claim 1 further comprising a means or device for sensing when the lid is open or closed.

11. The trash container of claim 10 wherein the means or device is a reed sensor.

12. The trash container of claim 1 further comprising a means or device for communicating the open-closed status of the lid to other components of the trash container.

13. The trash container of claim 12 further comprising a timer that allows the coin-operated mechanism to permit access to the trash container only at predetermined intervals or at predetermined times of the day.

14. A method for preventing the deposit of unauthorized trash or excess authorized trash into trash containers comprising:
providing individuals wanting to deposit trash into a trash container with access to a trash container comprising a body defining a substantially enclosed inner area suitable for receiving and containing trash; an opening in the body suitable for inserting trash into and removing trash from the body; a lid attached by one or more hinges to the body, the lid being configured to match the shape and size of the opening such that the body and the lid form an essentially enclosed inner area when the lid is placed over the opening; a latch means affixed to either the lid or to the body; an latch means receptacle affixed to either the lid or to the body, wherein the latch means receptacle is affixed to the lid if the latch means is affixed to the body or the latch means receptacle is affixed to the body if the latch means is affixed to the lid, wherein the lid is essentially sealed to the opening by operating the latch means so that the latch means is inserted into the latch means receptacle; and a coin-operated mechanism attached to the body or to the lid and coupled to the latch means such that the coin-operated mechanism is capable of operating the latch means to insert at least a portion of the latch means into or remove the latch means from the latch means receptacle, wherein the coin-operated mechanism is activated to remove the latch means from the latch means receptacle when a payment means triggers the coin-operated mechanism; and
requiring the individual to pay a fee using the coin-operated mechanism and the payment means to deposit an authorized amount of trash.

15. The method of claim 14 wherein the individual pays the fee with one or more of coins, paper money, credit cards, debit cards, tokens, magnetic stripe cards, magnetic field or radio frequency (RFID) devices, or combinations thereof.
